(19) United States
(12) Patent Application Publication
(10) Pub. No.: US 2015/0302181 A1
(43) Pub. Date: Oct. 22, 2015

(54) Method and System for Simplified Recording to Discrete Media

(71) Applicant: Samsung Electronics Company, Ltd., Suwon-si (KR)

(72) Inventor: Paul N. Fahn, Sunnyvale, CA (US)

(21) Appl. No.: 14/680,829

(22) Filed: Apr. 7, 2015

Related U.S. Application Data
(60) Provisional application No. 61/982,255, filed on Apr. 21, 2014.

(51) Int. Cl. G06F 21/10; H04L 29/06; G06F 17/30

(52) U.S. Cl. CPC G06F 21/10; G06F 17/30017; H04L 63/0428; G06F 2221/0744

(57) ABSTRACT

In one aspect, a method for recordation of a content is described. A device requests a copy of the content for a discrete media (DM). The device retrieves metadata that supports the format of the DM, processes such metadata to generate a file. The file contains the content. The device causes the content to be recorded onto the DM using the file.

### CROSS-REFERENCE TO RELATED APPLICATIONS

This application claims the benefit of U.S. Provisional Patent Application No. 61/982,255 filed on Apr. 21, 2014, which is fully incorporated herein by reference.

### TECHNICAL FIELD

One or more embodiments relate to computer networks and digital rights management. More specifically, one or more embodiments relate to secure delivery of media-bound content.

### BACKGROUND

There have been multiple efforts in developing mechanisms for digital distribution of a piece of audio, video, audio-visual or multi-media content or (“a title”). Existing solutions allow a consumer to purchase digital rights to a title to be able to repeatedly download or stream the same title to multiple devices owned by her, in accordance with the purchased digital rights. Some of such solutions become industry standards. Digital Entertainment Content Ecosystem (DECE) is a consortium with members engaging in standardization efforts of such solutions. Non-members of DECE, for example Disney™, are implementing their own standards to achieve similar goals.

As a further consumer benefit, one type of the digital rights to a title is a Discrete Media right. The Discrete Media right allows a customer to receive or create an authorized copy of a title to be securely bound to an instance of physical media, so that the customer can have the title in the form of a user-movable physical media, such as an optical disc, a flash memory card, or an external hard drive. Such physical media that can be removed from player devices and handled separately from any particular device are referred to as Discrete Media (DM). The user's right to a title securely bound to Discrete Media is referred to as a Discrete Media right (DM right).

A “DM home burn” operation allows a user to purchase a DM right associated with a title and target DM format. The user can “burn” (record) a copy of the title securely onto a recordable version of the target DM, using devices and solutions under control of the user, according to the DM right. Existing solutions support “DM home burn” by first downloading the title from an Internet server in an encrypted file, which is protected by a Digital Rights Management (DRM) or similar first content protection technology that provides access control and use control of digital content and devices. The downloaded file is then decrypted and transferred to a second content protection system associated with the target DM format. The second content protection system encrypts the decrypted file and causes the re-encrypted file to be securely recorded on an instance of the target DM. The resulting file is “media-bound” in that the resulting file is only playable as long as it remains on the same instance of the target DM. Any attempt to copy the file from the instance of the target DM results in a non-playable file. In the example of digital versatile disc or digital video disc (DVD) as the target DM format, the downloaded file is in a “ISO file” format, as defined in the DVD specifications and protected by a DRM such as PlayReady®. The second content protection system is “DVD CSS.” The ISO file is recorded onto a blank DVD using a CSS key management system. The DVD can then be handled separately from any DVD player device. Therefore, the user can physically bring the target DM to various player devices in her home, her car, her workplace, her friend's home or elsewhere. However, copying files from the recorded DVD onto a blank recordable DVD results in a non-playable disc.

However, there are issues with such existing solutions. First of all, existing solutions require downloading of the title for each “home burn” operation, which calls for a substantial expense in terms of time (completion of the transaction is time consuming and may lead to many hours of delay before the user can play the content), cost (the costs of downloading increase with size and resolution of the title and therefore such costs are rising significantly as the industry transitions to Ultra-high-definition (UHD) content) and bandwidth (bandwidth expense and bandwidth caps associated with the downloading channel). Second, the decryption of the downloaded file and then re-encryption (“DRM export”) may lead to security issues, because the content will be in the clear (unencrypted) in between the decryption and subsequent re-encryption; such clear content is a target for hackers and content pirates. Third, the existing solutions require a negotiated legal agreement between each DRM or each first content protection system and each second content protection system, which can be time-consuming, expensive in legal resources, and not scaling well (every DRM would need to conclude an agreement with every DM technology to be able to record the copy of the title to various target DM). Last but not least, all the above issues add up to poor user experience.

### SUMMARY

A method for recordation of a content includes requesting, at a first device, using a processor, a copy of the content for a discrete media (DM), retrieving a first metadata supporting the format of the DM, processing the first metadata to generate a first file comprising the content, and causing the content to be recorded onto and bound to the DM, using the first file.

A system for recordation of a content includes a memory, wherein the memory stores computer readable instructions, and a processor programmed to initiate operations, by executing the computer readable instructions. The operations include requesting a copy of the content for a discrete media (DM), retrieving a first metadata supporting format of the DM, processing the first metadata to generate a first file comprising the content, and causing the content to be recorded onto and bound to the DM, using the first file.

A computer readable storage medium that includes executable code embodied in a tangible form operable to perform recordation of a content. The computer readable storage medium includes executable computer code operable to request, at a first device, a copy of the content for a discrete media (DM), to retrieve a first metadata supporting format of the DM, to process the first metadata to generate a first file comprising the content, and to cause the content to be recorded onto and bound to the DM, using the first file.

This Summary section is provided merely to introduce certain concepts and not to identify any key or essential features of the claimed subject matter. Many other features and embodiments of the invention will be apparent from the accompanying drawings and from the following detailed description.

### BRIEF DESCRIPTION OF THE DRAWINGS

The accompanying drawings show one or more embodiments; however, the accompanying drawings should not be taken to limit the invention to only the embodiments shown. Various aspects and advantages will become apparent upon review of the following detailed description and upon reference to the drawings in which:

FIG. 1 is a diagram illustrating an exemplary environment;

FIG. 2A is an exemplary architecture for a computing system;

FIG. 2B is an exemplary architecture for a discrete media client;

FIG. 3 is a diagram illustrating an exemplary Common File Format file;

FIG. 4 is a flow chart illustrating an exemplary method of content recordation;

FIG. 5 is a flow chart illustrating exemplary steps of processing metadata and content file;

FIG. 6 is a diagram illustrating another exemplary architecture for a content file; and

FIG. 7 is a diagram illustrating an exemplary architecture for a package.

### DETAILED DESCRIPTION

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

One or more embodiments generally relate to secure delivery of media-bound content to a consumer. In accordance with the inventive arrangements described within this disclosure, media-bound content is an authorized copy of a piece of content or a title that is bound to a specific physical media, such as an optical disk, a flash memory card, or an external (removable) hard drive. Delivery of media-bound content is bundled with a digital right to the content purchased by a user. Binding a piece of content to a physical media is achieved by “burning” (recording) the content securely onto a recordable version of a target Discrete Media (DM) format; in a “home burn” this is done using devices and software under control of the user. Obtaining a DM copy of the content enables a user to bring the physical media to various player devices. For example, the user can bring the content to a friend's house and play the content on a device located in the friend's house. As defined herein, the terms “user” is used interchangeably with the term “consumer,” which means a human being. As defined herein, the term “content” is used interchangeably with the term “title,” which includes image, video, and multimedia data such as movies, games, etc.

In one aspect, the inventive arrangements described herein may be implemented as a method or process performed by a data processing system. In another aspect, the inventive arrangements may be implemented as an apparatus such as a data processing system having a processor. The processor, upon executing program code, may perform one or more operations described herein. In still another aspect, the inventive arrangements may be implemented as a non-transitory computer-readable storage medium storing program code that, when executed, causes a processor and/or a system to perform and/or initiate a method or process.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

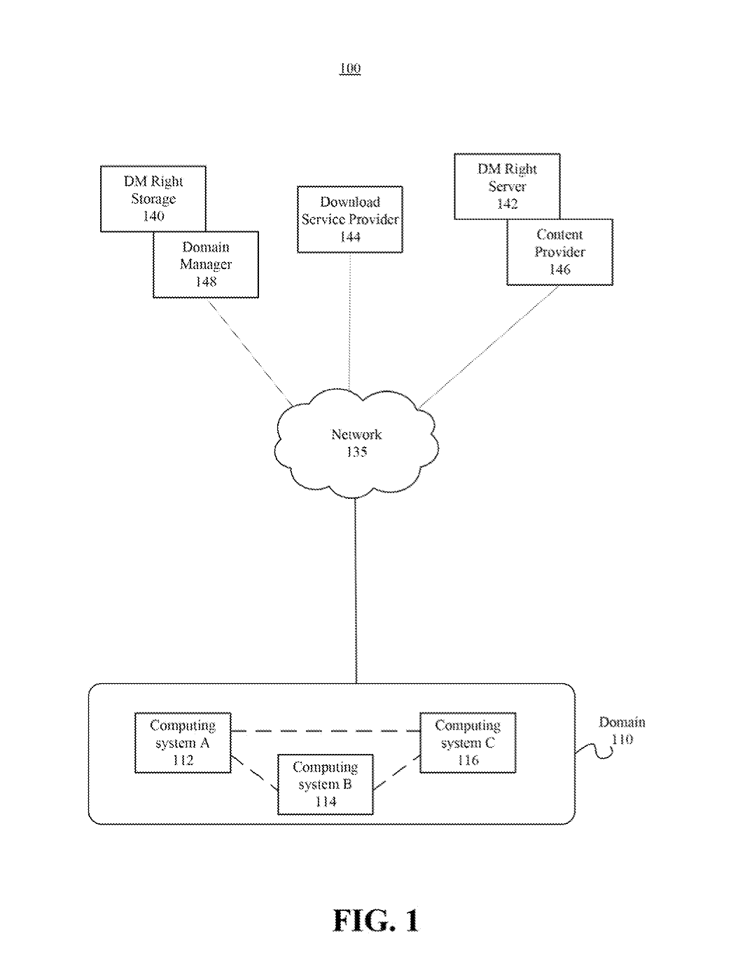

FIG. 1 is a network diagram illustrating an exemplary DM home burn environment 100. As pictured, environment 100 includes domain 110, which comprises three computing systems: system A 112, system B 114, and system C 116.

A domain may be an organization or a network of computing systems that comprises one or more users, for example, a household, a corporation, a facility, a school, and so on. One example of domain 110 and computing systems operating within it is a household and users are family members. Computing systems A 112, system B 114, and system C 116 may be various types of devices, operating using different software, protocol and/or operating systems, and in incompatible DM formats. A domain may be linked with a specific user or user account that any computing systems associated with the user or user account belong to the domain. For example, computing systems A 112, system B 114, and system C 116 are all registered under the same user identification. A domain may be a group of devices or users that are associated with the same service account, such as the same account from an MVPD (such as Comcast®) or an OTT service (such as iTunes® or Netflix®). A domain may also be a group of devices that are associated with either the same or different user, organization or network. For example, computing systems A 112, system B 114, and system C 116 belong to different users, and they are not associated with the same organization or network.

Domain 110 may be specified when a DM right is purchased. Multiple computing systems and devices may be registered under domain 110. These computing systems and devices may support different DM formats. For example, one device may support DM format of DVD while the other supports DM format of a flash memory card. Given the appropriate DM right, any computing system or device belonging to domain 110 is allowed to perform DM home burn of the same title authorized by the DM right. In other words, DM home burn operation is restricted to domain 110. In the household example, a piece of content may be first recorded as a DVD to be played by a DVD player and then a MP4 to be played by a MP4 player. However, without method and system described in this disclosure, the user needs to download various content files to have the same title recorded onto different registered devices.

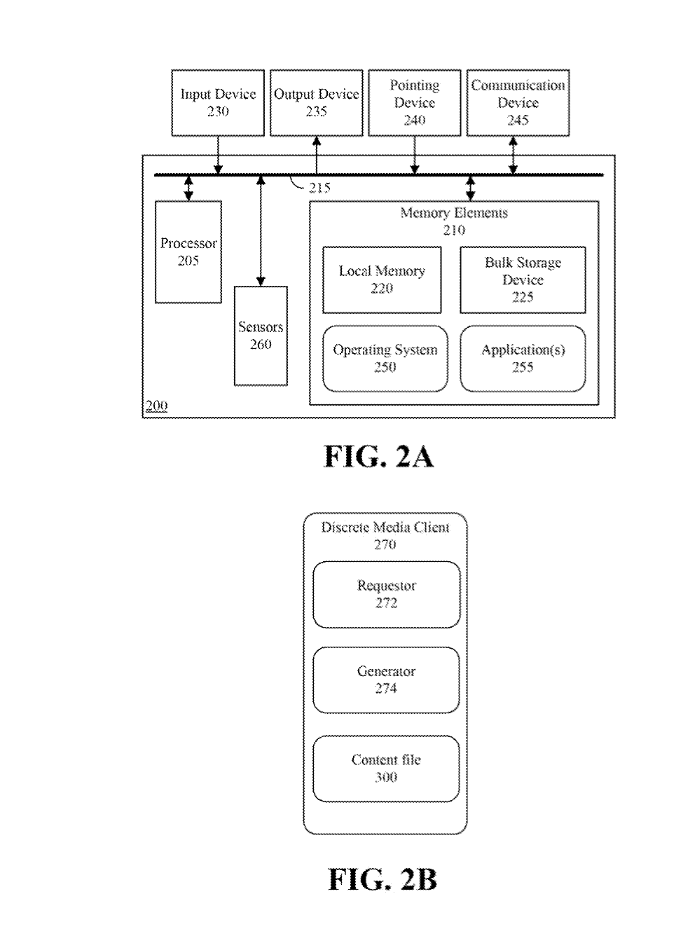

In one embodiment, computing systems 112, 114 and 116 may be data processing systems executing appropriate operational software and one or more applications and/or services. These systems may include one or more processors executing one or more applications, services, or other modules of program code. For example, system A 112 may be implemented using one or more physical servers, a cloud computing infrastructure, one or more virtual servers executing in one or more physical servers, or combinations thereof. FIG. 2A illustrates one example of such a computing system.

In one embodiment, each computing system may be capable of communicating with another computing system or one or more devices over a communication channel. Exemplary computing systems may include, but are not limited to, personal computer, laptop, mobile phones or mobile base stations such as “smart phones,” computing devices including wired or wireless transceivers such as tablet computing devices, and the like. The number of computing systems shown in FIG. 1 is for purposes of illustration only and is not intended as a limitation. It should be appreciated that fewer than three computing systems or more than three computing systems may be included within environment 100.

In one aspect, the term “communication channel” means a particular physical transmission medium such as a wire or an optical cable. In another aspect, the term “communication channel” means a particular logical connection and/or a particular communication protocol. In still another aspect, the term “communication channel” means a particular radio access technology (RAT). Examples of different RATs may include, but are not limited to, Near Field Communications (NFC), Bluetooth, 60 Hz (e.g., over power lines), Wi-Fi (IEEE 802.11x in reference to any of the 802.11 family of communication protocols), Worldwide Interoperability for Microwave Access (WiMax), Long-Term Evolution (LTE), Universal Mobile Telecommunications System (UMTS), Global System for Mobile/General Packet Radio Service (GSM/GPRS), or the like. Appreciably, a “wireless communication channel” generally refers to a particular RAT.

In one embodiment, network 135 is the medium used to provide communication links between various devices and computing systems connected together within environment 100. Network 135 may include connections, such as wire, wireless communication links, or fiber optic cables. Network 135 may be implemented using, or include, any of a variety of different communication technologies such as a Wide Area Network (WAN), a Local Area Network (LAN), a wireless network whether a WAN or a LAN, a mobile network, a Virtual Private Network (VPN), the Internet, the Public Switched Telephone Network (PSTN), or the like. Computing systems of domain 10 may share the same means of connectivity or may enjoy individual dedicated connection. In the household example, a cell phone may be connected through a cellular network while a laptop may share the same connection, such as a DSL or cable modem, with a game console.

There are various network services, such as DM right storage 140, DM right server 142, download service provider 144, content provider 146 and domain manager 148, connected to computing systems A, B and C in domain 110 via network 135. In one embodiment, DM right storage 140 may be an entity that stores every DM right purchased by a user to a piece of content. In another example, DM right storage 140 may be part of a Rights Locker, which includes other digital rights besides DM rights. DM right server 142 may be an entity that grants the DM right to the user and/or creates usage licenses for content in a DM format. Content provider 146 may be an entity that makes a piece of content available to users. It may be the network service provider to domain 110, virtual retailer, online market places, content distributor, licensing companies, etc. A content provider may be associated with its respective DM right server. A content provider may be associated with multiple DM right servers, located at various locations. Vice versa, a DM right server may be associated with multiple content providers at different locations. The piece of content may be created by separate content creators such as a production company, a record company, a studio, a publishing house, etc. Domain Manager 148 may be an entity that maintains identification of every domain that is associated with a DM right, every device within each domain, and/or every user within each domain.

The above described entities may reside in a cloud, may operate as independent individual server or may be provided by a network of servers. In one embodiment, DM right storage 140 and domain manager 148 are provided by one entity. In one embodiment, DM right server 142 and content provider 146 may be integrated as one entity. In one embodiment download service provider 144 and DM right server 142 are integrated and operated by one entity.

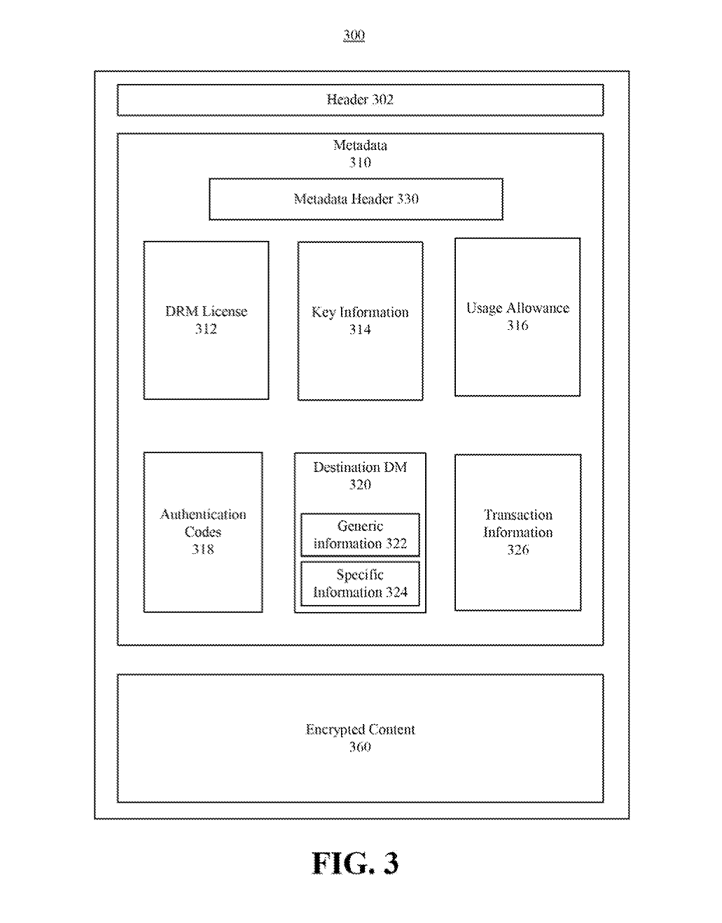

In one example of FIG. 1, computing systems of domain 110 may provide distinctive functions or services. For example, computing system A 112 may store or have access to a content file, which may have been downloaded by the user previously at the time of her purchase of the DM right of a title bundled with domain 110. The content file is in a Common File Format (“CFF”) that enables computing system B 114 and computing system C 116 to perform further DM home burn of the same title authorized by the DM right, without downloading additional content files. That is, computing system B 114 and computing system C 116 may recognize a CFF file and discern its contents in order to record the encrypted content of the CFF onto another DM that has a physical format differentiating from the one identified in the CFF. In one embodiment, a CFF may be as described in DECE Common File Format and Media Formats Specification, the content of which is incorporated by reference herein in its entirety and for all purposes. FIG. 3 illustrates a file format diagram for an exemplary CFF.

FIG. 2A is an exemplary architecture 200 for a computing system. In one example, architecture 200 may be used to implement computing system B 114 of FIG. 1. Architecture 200 may also be used to implement any of a variety of systems and/or devices that include a processor and memory and that are capable of performing the operations described within this disclosure. In some cases, the particular device and/or system implemented using architecture 200 may include fewer components or more components than pictured in FIG. 2A. Further, the particular operating system and/or application(s) included may vary. For example, architecture 200 may be used to implement a computing system with communication capacity by including appropriate transceivers and/or sensors such as a magnetometer, a mobile operating system, and/or one or more applications.

As pictured, architecture 200 includes at least one processor 205 coupled to memory elements 210 through a system bus 215 or other suitable circuitry. As defined herein, the term “processor” means at least one hardware circuit (e.g., an integrated circuit) configured to carry out instructions contained in program code. As an example and not by way of limitation, to execute instructions, processor 205 may retrieve (or fetch) the instructions from an internal register (not shown), an internal cache (not shown), local memory 220, or bulk storage device 225; decode and execute them; and then write one or more results to an internal register, an internal cache, local memory 220, or bulk storage device 225. In particular embodiments, processor 205 may include one or more internal caches for data, instructions, or addresses. This disclosure contemplates processor 205 including any suitable number of any suitable internal caches, where appropriate. In particular embodiments, processor 205 may include one or more internal registers for data, instructions, or addresses. This disclosure contemplates processor 205 including any suitable number of any suitable internal registers, where appropriate. Where appropriate, processor 205 may include a central processing unit (CPU), an array processor, a vector processor, a digital signal processor, a field programmable gate array (FPGA), a programmable logic array (PLA), an application specific integrated circuit (ASIC), programmable logic circuitry, a controller, one or more arithmetic logic units (ALUs), multi-core processor, and one or more processors 205.

Architecture 200 stores program code within memory elements 210. In particular embodiments, memory elements 210 include main memory for storing instructions for processor 205 to execute or data for processor 205 to operate on. Processor 205 executes the program code accessed from memory elements 210 via system bus 215. Memory elements 210 include one or more physical memory devices such as, for example, a local memory 220 and one or more bulk storage devices 225. As an example and not by way of limitation, instructions from bulk storage device 225 or another source is loaded to local memory 220. Processor 205 may then execute these instructions. During or after execution of the instructions, processor 205 may write one or more results (which may be intermediate or final results) to memory elements 210. Further, computing system B 114 may include one or more memory elements 210 configured to store data received from computing systems 112 and/or 116.

Local memory 220 refers to random access memory (RAM) or other non-persistent memory device(s) generally used during actual execution of the program code. This RAM may be volatile memory, where appropriate, and this RAM may be dynamic RAM (DRAM) or static RAM (SRAM), where appropriate. Moreover, where appropriate, this RAM may be single-ported or multi-ported RAM. This disclosure contemplates any suitable RAM. Architecture 200 may also include one or more cache memories (not shown) that provide temporary storage of at least some program code in order to reduce the number of times program code must be retrieved from bulk storage device 225 during execution.

Bulk storage device 225 may be implemented as a hard disk drive (HDD), a solid state drive (SSD), flash memory, an optical disc, a magneto-optical disc, magnetic tape, a Universal Serial Bus (USB) drive or a combination of two or more of these, or other persistent data storage device. Bulk storage device 225 may include removable or non-removable (or fixed) media, where appropriate. Bulk storage device 225 may be internal or external to computing system B 114, where appropriate. In particular embodiments, bulk storage device 225 is non-volatile, solid-state memory. In particular embodiments, bulk storage device 225 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory cards (e.g., secure digital (SD) card, miniSD, microSD, SDXC, compact flash card, etc.) or a combination of two or more of these. This disclosure contemplates bulk storage device 225 taking any suitable physical form. Where appropriate, bulk storage device 225 may include one or more bulk storage device 225. As an example, sensor data captured by sensors 260 may be stored into bulk storage device 225. Bulk storage device 225 may be combined with local memory 220. Bulk storage device 225 may save sensor data, input device data, output device data, pointing device data and communication device data in a machine readable raw format or in a human readable transformed format. In one embodiment, bulk storage device 225 may save metadata for a content file to be recorded onto a target DM.

Input/output (I/O) devices such as an input device 230, an output device 235, and a pointing device 240 may optionally be coupled to architecture 200. In some cases, one or more of the I/O devices may be combined. For example, a touch sensitive screen may be used as output device 235, as input device 230, and as pointing device 240. The I/O devices may be coupled to architecture 200 either directly or through intervening I/O controllers. According to various embodiments, input device 230 may be capable of receiving a user input via touch, voice, gesture, motion, or a combination of such. Input device 230 may receive user input via physical and/or virtual keypad, keyboard, touch sensitive surface, mouse, control bars, handles, balls or wheels, microphone, camera, stylus, and/or other input control means, individually or in combination. Output device 235 is configured to present data in various formats, including but not limited to, audible sound (e.g., beep, ring, spoken message, etc.), visual indicator (flashing, color variation, illumination variation, text, image, motion variation of content presently displayed, etc.), and/or tactile or haptic notion (e.g., vibrate). Output device 235 may present data output via speaker, monitor, LED, printer, scanner, projector, and/or other output display means, individually or in combination. Devices 230, 235 and 240 include hardware, software, or both. Computing system B 114 may include one or more of these interfaces, where appropriate. Where appropriate, devices 230, 235 and 240 may include one or more device or drivers enabling processor 205 to drive one or more of these interfaces.

One or more communication devices 245 may also be coupled to architecture 200 to enable architecture 200 to become coupled to other computing systems, devices, remote printers, and/or remote storage devices through intervening private or public networks. As an example and not by way of limitation, communication device 245 may include a network interface controller (NIC) or network adapter for communicating with an Ethernet or other wire-based network or a wireless NIC (WNIC) or wireless adapter for communicating with a wireless network, such as a Wi-Fi network. Such controller or adapter may be a modem, a cable modem, an Ethernet card, a wireless transceiver, etc. Depending upon the particular device implemented with architecture 200, the specific type of network adapter, or network adapters as the case may be, will vary. As an example and not by way of limitation, computing system B 114 may communicate with an ad hoc network, a personal area network (PAN), a local area network (LAN), a wide area network (WAN), a metropolitan area network (MAN), body area network (BAN), or one or more portions of the Internet or a combination of two or more of these. One or more portions of one or more of these networks may be wired or wireless. Computing system B 114 may also include antenna for communicating with a cellular telephone network. Computing system B 114 may include any suitable communication device 245 for any of these networks, where appropriate. Communication device 245 may include one or more computing system B 114, where appropriate. Although this disclosure describes and illustrates a particular communication device, this disclosure contemplates any suitable communication interface.

One or more sensors may also be coupled to architecture 200. According to various embodiments, sensors 260 include but not limited to accelerometer, thermometer, compass, acoustic sensor, light sensor, gyroscope, barometer, proximity sensor, Bluetooth, Global Position System (GPS) sensor, Wi-Fi, Wireless, clock, camera, Micro-Electro-Mechanical systems (MEMs) inertial sensor, etc. Data captured by sensors 260 help the determination of contextual information. As an example, real-time readings of the clock, accelerometer, Bluetooth and Wi-Fi may be used to identify the time, location, transportation mode detection, and/or movement orientation of computing system B 114. Sensor data is processed by processor 205 to assist monitoring of a user's status. Sensors 260 can be integrated with input device 230, output device 235 and pointing device 240. Sensors 260 can also be part of communication device 245.

As pictured in FIG. 2A, memory elements 210 store an operating system 250 and one or more applications 255. Applications 255, for example, may include discrete media client (DM client) 270, which is depicted in FIG. 2B. In one aspect, operating system 250 and application(s) 255, being implemented in the form of executable program code, are executed by architecture 200. As such, operating system 250 and application(s) 255 may be considered an integrated part of architecture 200. Operating system 250, application(s) 255, and any data items used, generated, and/or operated upon by architecture 200 are functional data structures that impart functionality when employed as part of a system implemented using architecture 200.

FIG. 2B illustrates a block diagram showing modules and data components that may execute and be accessed on an exemplary DM client 270. In one embodiment, DM client 270 may be installed on computing system B 114 by the manufacturer of such a system, or by 3^{rd} party service provider or application provider. In another embodiment, DM client 270 may be downloaded by the user from a 3^{rd} party website after purchase of computing systems B 114. DM client 270 may include requestor 272, generator 274 and content file 300 in CFF format. Requestor 272 may contact content provider 146 requesting a DM copy of a title to be recorded onto a target DM. Requestor 272 may further contact a local computing system for encrypted content of the title, which is included in another content file obtained in previous download of the same title. Requestor 272 may also retrieve metadata that is compliant with the target DM format. Generator 274 may operate on metadata to generate content file 300 to be recorded onto the target DM.

FIG. 3 illustrates a file format diagram showing format of content file 300 in accordance with various embodiments of the disclosure. In one embodiment, CFF format is required for content file 300 so that DM client 270 is able to take advantage of a previously obtained content file for subsequent DM home burn operations, as long as such operations are authorized by the purchased DM right of the title. CFF may have open-ended data architecture that is suitable and scalable for all types of content description data. Employment of CFF eliminates the requirement of multiple downloads of DM copies of the same title, in order to obtain a content file in a format compatible with the target DM format. CFF, as demonstrated by its name, is an interoperable format shared by both the download fulfillment of the user-owned DM right and any of the target DM format allowed or approved by the DM right to the title. In one embodiment, when the user purchases the DM right of a title, one of her domain-registered devices downloads content file 300A in CFF-format from an Internet-based source. Such a CFF-format content file is thus “domain-bound” as it can be moved among the user's multiple domain-registered devices and can be played on any of them.

In one embodiment, content file 300 has various data fields including metadata 310 and encrypted content 360. In one embodiment, metadata 310 is information necessary to perform DM home burn and any transformation necessary to create the media-bound copy in the target DM format. Metadata 310 can be descriptive or non-descriptive, and in general may vary based on the target DM format. Encrypted content 360 storing the actual title, which is protected using a Common Encryption (“CE”) method. CE is shared by the first content protection technology and the second content protection technology involved in DM home burn operation to allow DM client 370 to avoid decrypting encrypted content 360 and re-encrypting the decrypted file. Instead, DM client 370 may hand over encrypted content 360 to the target DM content protection system, which supports CE, to have encrypted content 360 recorded onto the target DM. As described in one embodiment, a CE method may be based on ISOBMMF and MPEG as defined in ISO/IEC 14496-12, the content of which is incorporated by reference herein in its entirety and for all purposes.

Metadata 310 in general may vary based on the target DM format. It may include one or more data items. In one embodiment, metadata 310 may include DRM license 312, key information 314, usage allowance 316, authentication codes 318, destination DM 320 and transaction information 326. DRM license 312 may identify the DM right to the title. It protects the title either before it is recorded onto the target DM, or after such recording. DRM license 312 may include any discrete set of information about the encryption key or other processing data used to encrypt or protect the title. Key information 314 may provide information about the key(s) used to encrypt and/or decrypt the title. It may include the key(s) themselves and such key(s) may be encrypted themselves. Usage allowance 316 may provide information about the allowed usage of the title enabled by the purchased DM right. For example, it may include restriction about time limit of playback of the title, user identification, account identification, domain identification, number of plays, rendering allowance and/or decrypting devices, approved outputs or exports, etc. Authentication codes 318 may include data to ensure the integrity of the content for various portions of the content included in content file 300. Destination DM 320 may provide information about the target DM, on which the title will be recorded. It may include both generic information 322 such as the type of media, and specific information 324 such as a serial number of a specific instance of a recordable disc or memory card/chip. Transaction information 326 may provide information about the transaction, by which the user is authorized to access the title. This may include identifying a retail store, either physical or on-line, at which the title was purchased or rented. Transaction information 326 may further provide a date or transaction number identifying the purchase or other relevant transactions; it may also provide the user identification, user account identification, and/or domain identification associated with the transaction. The data of above described field may take various forms, such as plain text, a structured data format or a URL to specific network component. Metadata 310 may include further information that may be deemed necessary to support additional operations or transformation authorized by the DM right to the title purchased by the user. Ordinary people skilled in the art will appreciate that metadata 310 may include metadata header 330 field or header data box, which describes the overall data or information included in metadata 310 header, such as type, characteristics, numbers of the data items, and size of overall data of the data items, date item structure, data item type, etc. Further, each individual field included in metadata 310, such as DRM license 312, key information 314, usage allowance 316, authentication codes 318, destination DM 320 and transaction information 326 described above, may have its independent sub-header field. Content file 300 may also have header 302 that describes the overall data or information included in content 300.

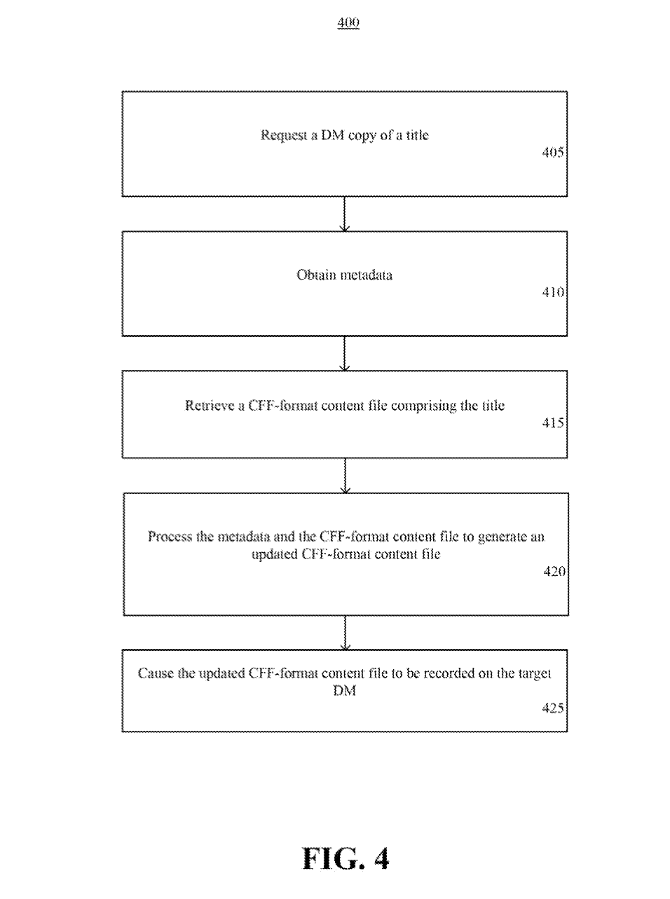

FIG. 4 is a flow chart illustrating an exemplary method 400 of improved DM home burn operation, by which the same title may be recorded onto any one or all of a user's devices in any physical media format, as long as these devices are registered under the domain or account associated with the DM right that allows the user to obtain the title and record it onto such devices. Method 400 may be performed by computing system B 114 of FIG. 1 by invoking DM client 270. For example, computing system B 114 may contact one or more content providers 146 requesting a title to perform DM home burn operation of the title. Computing system B 114 may obtain metadata 310 for the target DM from one or more computing systems A 112, retrieve CFF-format content file 300 from one or more computing systems C 116, and process the content file 300 and the metadata 310 to cause the title to be recorded onto the target DM.

Method 400 may begin at block 405. DM client 270 of computing system B 114 may request a DM copy of a title, upon notification that the user plans to perform a DM home burn operation of the title onto a target DM. DM client 270 may send such a request to a server, such as content provider 146 or DM right server 142. DM client 270 may obtain the server information by default, from user input, or by inquiring known public available information sources, such as its ISP. The default server information may be provided by the provider of DM client 270, or defined by the provider of the title. The default server information may be provided in various categories to comply with privacy regulations. The user may exercise various levels of control when entering server information. For example, the user may exercise parental control by specifying whether one or more servers may be accessed by certain age group(s). The user may provide user dependent server information to preserve private information. The server information may vary depending on the characteristic, category, rating, collective user comments, geographic restriction, age restriction or other factors of the title. The server information may further depend on the DM format specified by the DM right associated with the requested title. The server information may designate one server for a “purchase” right, and another server for a “rental” right. The server information may also be provided based on communication efficiency, such as data transmission speed, bandwidth, encryption complexity if data is encrypted, etc., between DM client 270 and the server. The server information may further adapt to the age of the user, context of the user or limitations of the domain. For example, only server information of a server that supports CFF may be available.

In one embodiment, DM client 270 may contact DM right storage 140 to obtain a domain identifier, which may be a name for domain 110 or a more technical identifier. DM client 270 may provide its own identifier or a device identifier to obtain the corresponding domain identifier.

In one embodiment, the DM copy request may include a domain identifier, the name of the title or a title identifier, the delivery method of the title, the target DM format identifier and a device ID. The domain identifier identifies the domain that is identified at the time when the user purchased the DM right to the title. The device ID identified computing system B 114 that runs DM client 270. In some embodiments, only the domain identifier is included. In some embodiments, the domain identifier is a service account ID.

In one embodiment, the server may be Download Service Provider (DSP) 144. In another embodiment, the server may be content provider 146. Ordinary people skilled in the art will appreciated that DSP 144 and content provider 146 may be integrated into one entity. Upon receipt of the DM copy request from DM client 270, the server first verifies whether the request does arise from a domain that has the DM right to the requested DM copy of the title. The server may also verify whether the device identifier representing a device that is registered under the domain. The server may contact domain manager 148 to verify the existence of the identified domain and the devices registered with such a domain. The server may also contact DM right storage 140 to check whether the identified domain is associated with a DM right. The server may further contact DM right server 142 to determine whether the DM right associated with the identified domain authorizes the requested DM copy of the title for the identified target DM format. If the identified domain does not exist, the identified device is not registered with the identified domain, the identified domain is not associated with a DM right, the DM right does not authorize the DM copy for the target DM format of the requested title, or the identified device is not registered under the identified domain, method 400 ends; at this point the user may be allowed to enter a new transaction to purchase a DM right, after which method 400 may continue or restart. Error information may be provided to DM client 270 explaining why the DM copy request cannot be satisfied. The server may further recommend solutions to DM client 270 to resolve the issues.

In one embodiment, upon verification that the user's right to the title indeed includes such an as-yet-unfulfilled DM copy for the target DM format, DSP 144 may further determine whether the user has requested a DM copy of the same title previously. In one embodiment, DM right server 142 may maintain information of every DM copy request and completed download of it. If the user has requested or downloaded the same title previously, DSP 144 may cause DM client 270 to receive metadata 310B to help recordation of the DM copy of the title to the target DM. Otherwise, DSP 144 will cause DM client 270 to download content file 300 comprising requested title.

At block 410, DM client 270 obtains metadata 310B in response to the DM copy request, upon successful verification of the request. In one embodiment, DM right server 142 or DSP 144 may provide metadata 310B directly to DM client 270. In another embodiment, DSP 144 may obtain metadata 310B from a 3^{rd} party entity such as content provider 146. In another embodiment, DSP 144 may provide a pointer, such as a network address, an entity identifier, URL or an email address, to DM client 270 so that DM client 270 may retrieve metadata 310B from another system or device pointed to by the pointer. In yet another embodiment, DSP 144 may only authorize DM client 270 to continue the DM home burn operation for the requested title without providing metadata 310B or information as to from where to obtain such metadata 310B. DM client 270 may contact alternative sources to obtain metadata 310B. For example, DM client 270 may get a copy of metadata 310B from a friend of the user, who has recently obtained the current metadata 310B for recordation of the same title onto the same type of target DM.

In one embodiment, DSP 144 may further provide local server information of a media server that is local to DM client 270. DM client 270 may contact the media server, based on the local server information, to carry out subsequent operations and communications. In another embodiment, DSP 144 does not provide such local server information. Instead, DM client 270 may obtain the local server information of the media server by local search (within the local network environment), by default or from user input. The default local server information may be provided by the provider of DM client 270, or manager of the local network in which DM client 270 resides, or by a network discovery service. There may be one or more media servers that are local to DM client 270. The local server information may vary based on the characteristic, category, rating and other factors of the title. The local server information may also differ based on privacy or security settings or limitations of DM client 270. The local server information may be further provided based on factors such as communication efficiency between DM client 270 and the one or more media servers, capacity of the one or more media servers, privacy or security settings or limitations of the one or more media servers, compatibility between DM client 270 and the one or more media servers, or a combination thereof. The local server information may also be provided by a directory of locally available resources. The local server information may further be provided based on the application being used by the consumer, or by a local network discovery service. Ordinary people skilled in the art will appreciate that local discovery of devices or servers may not always be available.

The term “local” here refers to local network, or private network, that interconnects devices within a limited area or a single location such as a home, an office, a school, a building, etc. “Local devices” and “local systems” are linked without relying on leased telecommunication lines. “Local device” and “local system” are used in contrast to devices and systems accessible via Internet, a global and public network.

In one embodiment, the local media server may be computing system A 112 of FIG. 1. The local media server may be a home media server. The local media server may be directly connected to DM client 270 via wired or wireless local network. The local media server may also be connected to DM client 270 via other devices and systems. The local media server may also be implemented on the same device as the DM client 270. The local media server may have a storage unit or have access to a storage unit that has maintained a content file of the requested DM copy of the title in CFF format, as illustrated in FIG. 3. Computing system A 112 may maintain a copy of content file for each individual title. For example, a series of content files may be accessible by computing system A 112 for corresponding episodes of a TV series, or corresponding media content of an album. For another example, one content file may be able to represent all episodes of the TV series or media content of the album. The latter sometimes may be referred to as a package. FIG. 7 illustrates an example of package format. The copy of content file may be obtained as a result from previous DM copy request for the same title, by DM client 270 or another system or device. A package may also contain one or more titles, such as a movie together with its sequels. Ordinary people skilled in the art will appreciate that there may be more than one local media servers belonging to domain 110. Also, a content file or package may be distributed among multiple such local media servers.

At block 415, DM client 270, based on information from DSP 144, may contact one or more local media servers to retrieve a content file 300A, which comprises the same title as the one identified in the DM copy request. Content file 300A includes metadata 310A and encrypted content 360A. Metadata 310A provides information assisting recordation of the same title to a DM identified in a previous DM home burn operation. In one embodiment, content file 300A may be obtained at the time the user purchased DM right(s) of the same title. The purchase caused a local device, which is one of her domain-registered devices, to download content file 300A containing that title. In another embodiment, content file 300A may be obtained when the user, or another user associated with the same domain or service account, previously requested a DM copy of the same title. However, as the target DM format may differ from all previous operations, metadata contained in the content file 300A may not be useable, or may not be sufficient, for assisting recordation of the title onto the target DM.

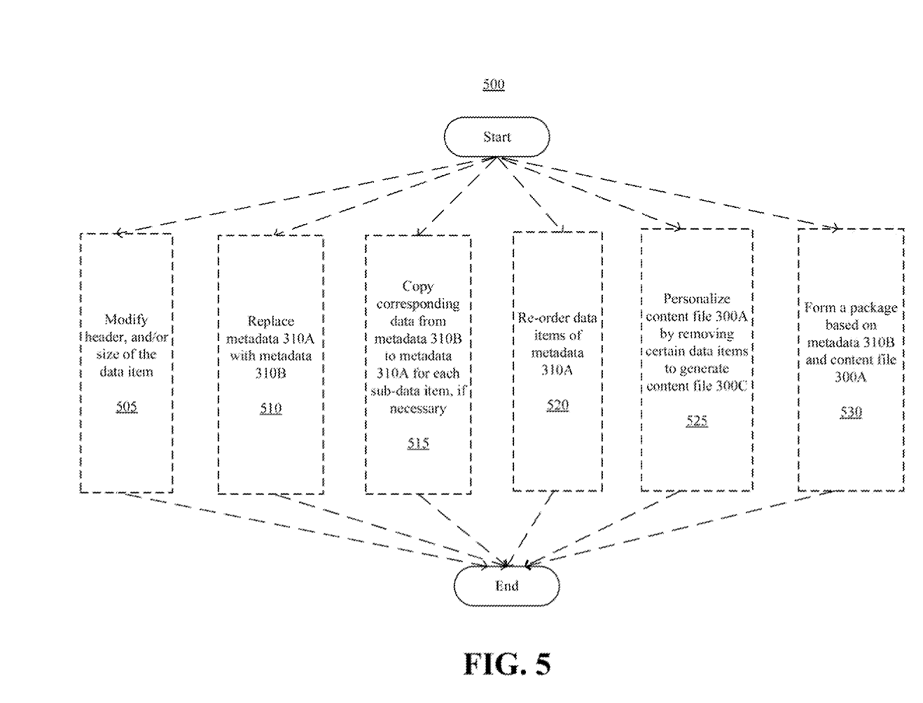

At block 420, DM client 270 processes both metadata 310B and content file 300A to generate content file 300C so that the title can be recorded onto the target DM. Various methods may be employed for such processing. In one embodiment, steps illustrated in FIG. 5 are followed to combine metadata 310B with content file 300A to generate content file 300C to complete DM home burn operation.

At block 425, DM client 270 may cause content file 300C to be recorded onto the target DM and to be media-bound to that instance of the DM format. The user is now free to use the DM copy to play the title on any device that supports the DM format, even if the device is not owned by her or is not registered to domain 110. As content file 300C contains still-encrypted content 360B, DM client 270 may hand content file 300C to another system or device that is capable of causing content file 300C to be recorded onto the storage media in the target DM format.

Various steps may be taken to process metadata 310B and content file 300A to generate content file 300C. As illustrated in FIG. 3, metadata 310B may include multiple data items such as DRM license, key information, usage allowance, authentication codes (such as hash values, MAC, digital signatures, etc.), destination DM format, destination DM media ID, transaction information, etc. Therefore, metadata 310B may comprise a series of data items, which may form structures such as a hierarchy, a nested data structure, a box within a box, parent-children, a linked-list, a tree, etc. In one embodiment, content file 300A may be viewed as a container file or a package that contains a variety of different types of media files or other type of data files.

FIG. 5 is a diagram illustrating aforementioned processing of metadata and content file, as described with reference to block 420 of FIG. 4, in more details. The processing may take none, some or all of the identified steps, or additional steps, to combine metadata 310B and content file 300A to generate content file 300C.

Block 505 shows one embodiment that, when metadata 310A and metadata 310B are processed to generate metadata 310C, header fields such as header 302A and metadata header 330A may need to be updated to indicate the changes caused by copying certain data from metadata 310B or changes to metadata 310A, such as data size of content file 300C, data size of metadata header 330C, fields or data boxes included in metadata 310C, etc. In yet another embodiment, metadata 310C may be created by removing data items that do not exist in metadata 310B from metadata 310A of content file 300A.

Block 510 shows one embodiment when metadata 310B completely replaces metadata 310A of content file 300A to create content file 300C for the DM home burn operation. In another embodiment, metadata 310B and metadata 310A may have exactly the same data items and date for each data item. No further action is required to process metadata 310A, and content file 300A can be used to perform the DM home burn operation.

Block 515 shows one embodiment, in which the types of data items of metadata 310B may match the types of the metadata 310A of content file 300A. However, the specific data of one or more data items vary. Metadata 310C may, thus, be an updated version of metadata 310A with only data items containing different data changed to the data of the corresponding data items of metadata 310B.

In one embodiment, a data item within metadata 310 may contain one or more sub-data items in a nested data structure. In one embodiment, only a portion of the sub-data items of such a data item of metadata 310A needs to be updated with corresponding data from metadata 310B. The one or more sub-data items may include individual header or a similar data structure specifying the type and size of data it contains, each individual header needs to be updated or re-calculated as well.

In one embodiment, data items or sub-data items of metadata 310A may need to be re-ordered, as illustrated in block 520, based on metadata 310B and/or specific context of the user requesting DM home burn operation, to generate metadata 310C. For example, the DRM License may need to move before or after the Transaction Information. For another example, the Authentication Codes may need to be moved after the Encrypted Content. Sometimes, the order of the data items or sub-date items may be arbitrarily specified by the DM format.

In one embodiment, in order to align with the target DM format, metadata 31 OA may change one or more data item descriptions or description of the content in encrypted content 360A, based on metadata 310B, to generate metadata 310C. For example, content synopsis or cast list included in metadata 310B may replace that found in metadata 310A.

Block 525 shows one embodiment, in which metadata 310A may further be personalized to generate metadata 310C, based on information of the user or domain 110 or computing system 114. For example, domain 110 may specify the language preference of the user. Metadata 310A can be further updated to create metadata 310C with certain audio and/or subtitle data removed, based on the language preference of the consumer. It is to be understood that such an update may result in a reduced sized content file 300C, which would save storage space and processing time during the DM home burn operation.

In one embodiment, one data item of metadata 310B is DRM license 312B. DM client 270 may need to process DRM license 312B by creating a new data item in metadata 310C to hold such a DRM License. For example, if content file 300 is in ISOBMFF format, ‘pssh’ box is one possible location for holding a DRM License. If metadata 310A already has DRM license 312A, DM client 270 may need to replace it with DRM license 312B from metadata 310B, or may add DRM license 312B in addition to keeping DRM license 312A. In one embodiment, DRM license 312B is placed in a separate file in the same package as content file 300C. If metadata 310A does not contain DRM license 312A, the ‘pssh’ box may be created in metadata 310C to hold DRM license 312B.

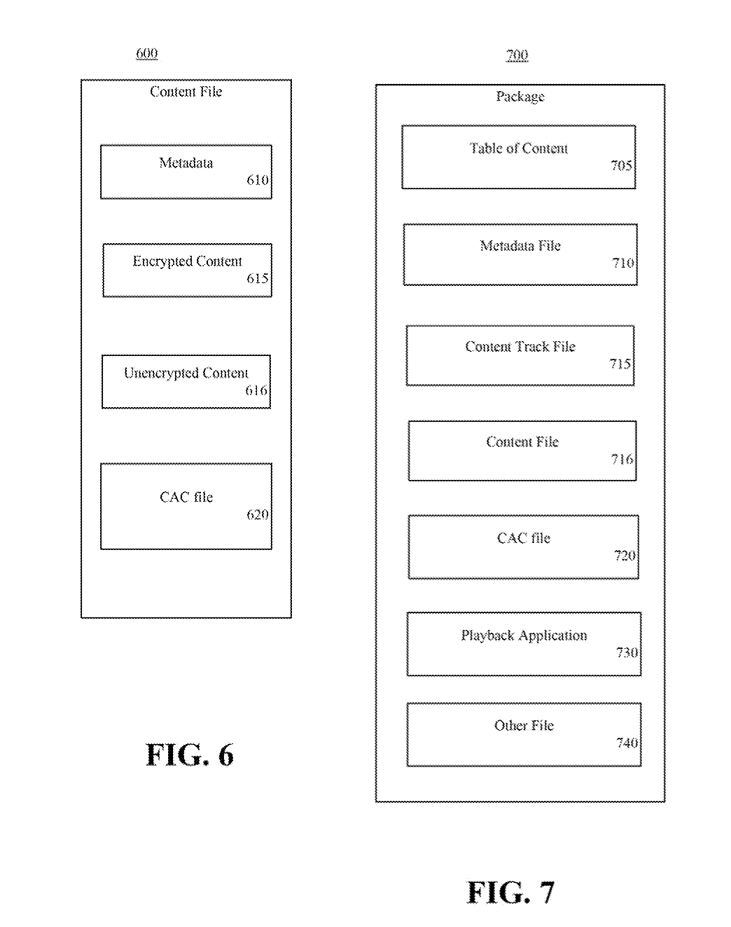

In one embodiment, DM client 270 may process the DRM License of metadata 310B by placing information about the encryption key in the ‘pssh’ box of content file 300C. In another embodiment, DRM license 312B includes or refers to a Content Authentication Code (CAC) file and DM client 270 may process the CAC file by inserting it into content file 300C. Metadata 310B may provide information enabling DM client 270 to obtain the CAC file. FIG. 6 illustrates that content file 300C may include metadata 610, encrypted content 615 and CAC 620, with CAC 620 forming its own data item independent from metadata 610. FIG. 6 further illustrates that content file 300C may include unencrypted content 616. In one example, unencrypted content 616 may contain commentary information, trailers or other extra information that may be related to encrypted content 615.

In one embodiment, metadata 310A and metadata 310B may be combined to be placed into one or more separate metadata files. These metadata files may be further combined with content file 300A to form a package 700, which is illustrated in block 530, and further in FIG. 7.

In one embodiment, package 700 may include a combination of file types, such as table of content 705, metadata file 710, content track file 715, content file 716, CAC file 720, playback application 730, and other type of file 740. Content track file 715 may include encrypted content, unencrypted content, or a combination thereof. Package 700 may contain every type of the aforementioned file types, or it may contain a portion of these file types. Also, package 700 may contain one or more files for each file type. For example, package 700 may include no content track files but one or more content files. In one embodiment, package 700 is based on SMPTE Media Package Format (SMPTE-defined Media Package Specification ST 2053), the content of which is incorporated by reference herein in its entirety and for all purposes. In one embodiment, package 700 may combine an XML formatted table of content file 705 with the rest of the aforementioned files into a single ZIP file that can be stored and distributed as a single object using simple file transfer protocols such as HTTP.

In one embodiment, package 700 may be required when the requested DM copy of a title is a season of a TV series. One or more content file 716s may be required for the requested multiple episodes of the TV series. In another example, package 700 may be required when related movie titles (such as a movie and its sequels) are purchased and downloaded together. One or more content track file 715s may be required for these movie titles. Ordinary people skilled in the art will appreciate that package 700 may assume alternative formats distinctive from the ones described above to accommodate requirement of the target DM.

When the ultimate file that will be recorded into the target DM is in package format, DRM License and content files may be saved in separate files within the package. In one embodiment, this step includes inserting CAC file, whose information is provided by metadata 310B, into package 700.

It can be appreciated that the present disclosure will significantly reduce cost and time associated with a DM home burn operation as download of a complete content file comprising a title is no longer required. Methods and systems disclosed may significantly reduce the overall cost associated with the DM home burn operation as communication bandwidth is saved, so does waiting time as much less time is expected to be spent waiting for completion of downloading of the content file.

It can be further appreciated that the present disclosure will improve security of DM home burn operation. Methods and systems disclosure do not require decryption of the content during the transaction. Existing practice of decryption and then re-encryption introduces a weak point in the security, which point may be subject to attack by content pirates or others seeking illegal copies of the content.

For purposes of explanation, specific nomenclature is set forth to provide a thorough understanding of the various inventive concepts disclosed herein. The terminology used herein, however, is for the purpose of describing particular aspects of the inventive arrangements only and is not intended to be limiting.

As defined within this disclosure, the terms “a” and “an” mean one or more than one. The term “plurality,” as defined herein, means two or more than two. The term “another,” as defined herein, means at least a second or more. The term “coupled,” as defined herein, means connected, whether directly without any intervening elements or indirectly with one or more intervening elements, unless otherwise indicated. Two elements may also be coupled mechanically, electrically, or communicatively linked through a communication channel, pathway, network, or system.

The term “and/or” as defined herein means any and all possible combinations of one or more of the associated listed items. The terms “includes” and/or “including,” when used in this disclosure, specify the presence of stated features, integers, steps, operations, elements, and/or components, but do not preclude the presence or addition of one or more other features, integers, steps, operations, elements, components, and/or groups thereof. Although the terms “first,” “second,” etc. may be used herein to describe various elements, these elements should not be limited by these terms, as these terms are only used to distinguish one element from another unless the context indicates otherwise.

As defined herein, the terms “if,” “when,” “upon,” mean in response to detecting and/or determining or responsive to detecting and/or determining. For example, the phrase “if [a stated condition or event] is detected,” means in response to determining and/or detecting [the stated condition or event].” As defined herein, the terms “in response to” and/or “responsive to” mean responding or reacting readily to an action, event, or condition. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se. A computer readable storage medium may be, but is not limited to, an electronic storage device, a magnetic storage device, an optical storage device, an electromagnetic storage device, a semiconductor storage device, or any suitable combination of the foregoing. A non-exhaustive list of more specific examples of a computer readable storage medium may include: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing.

A computer program product may include a computer readable storage medium (or media) having computer readable program instructions thereon for causing a processor to carry out aspects of the present invention. Computer readable program instructions described herein may be downloaded to respective computing/processing devices from a computer readable storage medium or to an external computer or external storage device via a network, for example, the Internet, a LAN, a WAN and/or a wireless network. The network may include copper transmission cables, optical transmission fibers, wireless transmission, routers, firewalls, switches, gateway computers and/or edge devices including edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations for the inventive arrangements described herein may be assembler instructions, instruction-set-architecture (ISA) instructions, machine instructions, machine dependent instructions, microcode, firmware instructions, state-setting data, or either source code or object code written in any combination of one or more programming languages, including an object oriented programming language and/or procedural programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some cases, electronic circuitry including, for example, programmable logic circuitry, an FPGA, or a PLA may execute the computer readable program instructions by utilizing state information of the computer readable program instructions to personalize the electronic circuitry, in order to perform aspects of the inventive arrangements described herein.

Certain aspects of the inventive arrangements are described herein with reference to flowchart illustrations and/or block diagrams of methods, apparatus (systems), and computer program products. It will be understood that each block of the flowchart illustrations and/or block diagrams, and combinations of blocks in the flowchart illustrations and/or block diagrams, may be implemented by computer readable program instructions, e.g., program code.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the operations specified in the flowchart and/or block diagram block or blocks.

The computer readable program instructions may also be loaded onto a computer, other programmable data processing apparatus, or other device to cause a series of operations to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects of the inventive arrangements. In this regard, each block in the flowchart or block diagrams may represent a module, segment, or portion of instructions, which comprises one or more executable instructions for implementing the specified operations. In some alternative implementations, the operations noted in the blocks may occur out of the order noted in the figures. For example, two blocks shown in succession may be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The description of the inventive arrangements provided herein is for purposes of illustration and is not intended to be exhaustive or limited to the form and examples disclosed. Modifications and variations may be apparent to those of ordinary skill in the art without departing from the scope and spirit of the described inventive arrangements.

The terminology used herein was chosen to explain the principles of the inventive arrangements, the practical application or technical improvement over technologies found in the marketplace, and/or to enable others of ordinary skill in the art to understand the embodiments disclosed herein.

What is claimed is:

1. A method for recordation of a content, comprising:
requesting, at a first device, using a processor, a copy of the content for a discrete media (DM);
retrieving, using the processor, a first metadata supporting format of the DM;
processing, using the processor, the first metadata to generate a first file comprising the content; and
causing the content to be recorded onto and bound to the DM, using the processor, using the first file.

2. The method of claim 1, further comprising:
retrieving, using the processor, a second file comprising the content from a second device, wherein the second device is local to the first device.

3. The method of claim 2, wherein the second file includes a second metadata.

4. The method of claim 2, wherein processing the first metadata includes processing the first metadata and the second metadata.

5. The method of claim 2, wherein the content of the first file comes from content of the second file.

6. The method of claim 1, wherein the first file is in Common File Format (CFF).

7. The method of claim 1, wherein the first file comprises an encrypted data of the content using a Common Encryption (CE) method.

8. The method of claim 1, further comprising:
acquiring a right to the content, using the processor, wherein the right allows recordation of the content onto the DM; and
retrieving the first metadata upon acquiring of the right to the content.

9. A system for recordation of a content, comprising:
a memory, wherein the memory stores computer readable instructions;
a processor programmed to initiate operations, by executing the computer readable instructions, comprising:
requesting a copy of the content for a discrete media (DM);
retrieving a first metadata supporting format of the DM;
processing the first metadata to generate a first file comprising the content; and
causing the content to be recorded onto and bound to the DM, using the first file.

10. The system of claim 9, the operations further comprising:
retrieving a second file comprising the content from a second device, wherein the second device is local to the first device.

11. The system of claim 10, wherein the second file includes a second metadata.

12. The system of claim 10, wherein processing the first metadata includes processing the first metadata and the second metadata.

13. The system of claim 10, wherein the content of the first file comes from content of the second file.

14. The system of claim 9, wherein the first file is in Common File Format (CFF).

15. The system of claim 9, wherein the first file comprises an encrypted data of the content using a Common Encryption (CE) method.

16. The system of claim 9, the processor programmed to initiate operations further comprising:
acquiring a right to the content, wherein the right allows recordation of the content onto the DM; and
retrieving the first metadata upon acquiring of the right to the content.

17. A computer readable storage medium that includes executable code embodied in a tangible form operable to perform recordation of a content, wherein the computer readable storage medium includes:
executable computer code operable to request, at a first device, a copy of the content for a discrete media (DM);
executable computer code operable to retrieve, at the first device, a first metadata supporting format of the DM;
executable computer code operable to process, at the first device, the first metadata to generate a first file comprising the content; and
executable computer code operable to cause the content to be recorded onto and bound to the DM, by the first device, using the first file.

18. The computer readable storage medium of claim 17, further comprising:
executable computer code operable to retrieve, at the first device, a second file comprising the content from a second device, wherein the second device is local to the first device.

19. The computer readable storage medium of claim 18, wherein the second file includes a second metadata.

20. The computer readable storage medium of claim 18, wherein process the first metadata includes processing the first metadata and the second metadata.

21. The computer readable storage medium of claim 17, wherein the content of the first file comes from content of the second file.
